(19) United States
(12) Patent Application Publication
(10) Pub. No.: US 2006/0056270 A1
(43) Pub. Date: Mar. 16, 2006

(54) Suction set structure for bone surgery

(76) Inventor: George Lee, Taipei (TW)

Correspondence Address: Yi-Wen Tseng, 4331 Stevens Battle Lane, Fairfax, VA, 22033, US

(21) Appl. No.: 10/938,625

(22) Filed: Sep. 13, 2004

(51) Int. Cl. B01F 13/06

(52) U.S. Cl. 366/139

(57) ABSTRACT

A suction set structure for bone surgery, which facilitates the removal and installation of an inner barrel, includes a suction handle, a suction tip, a fixing mount engaged with the inner barrel, and a rear cap. The suction tip connects to the inner barrel installed inside the suction handle. The inner barrel has a plurality of apertures which permit blood and bone dust to pass through and enter into the connecting tube of the rear cap while the larger bone chip is collected inside the inner barrel. The fixing mount includes a ring portion, a connecting portion, and a rib flange extending from the ring portion. The rib flange will be located between the rear open end of the suction handle and the rear cap. Such that, the chip bone collected inside the inner barrel will not slip out during the removal of the inner barrel. The removed inner barrel is also capable of standing upright by the fixing mount.

### BACKGROUND OF THE INVENTION

The present invention relates in general to a suction set structure for bone surgery, and more particularly, to a structure which enables medical personal to easily remove or install an inner barrel in a suction handle of the suction set. Detaching of the inner barrel will not result in falling of the bone chip collected. Further, the inner barrel is capable of standing upright rather than tilting down.

As illustrated in FIG. 1 and FIG. 2, a conventional suction set for bone surgery includes a suction handle 1, an inner barrel 11, a suction tip 12, and a set of connector 13 and connecting tube 131. One end of the suction handle 1 connects to the suction tip 12 while the other end of the suction handle 1 connects to the connector 13. The inner barrel 11, at both ends thereof having an opening, is installed inside the suction handle 1. The inner barrel 11 has a plurality of apertures which allow liquid or tiny particles to pass through. One of the opening of the inner barrel 11 opposes to the suction tip 12 while the other the opening opposes to the connecting tube 131. To assemble the suction set, one end of the inner barrel 111 is slipped onto a protruding portion 14 formed inside one end of the suction handle 1, and the connector 13 is secured onto the suction handle 1 to press against the other end of the inner barrel 11 by its inner surface. Consequently, the suction tip 12, the inner barrel 11, and the connecting tube 131 are connected continuously. To utilize the suction set in a bone surgery, the connecting tube 131 of the suction set is connected to an aspirator while the suction tip 12 of the suction set is utilized to perform suction operation. This operation draws the bone chip into and stores inside the inner barrel 11 while the blood and the bone dust are exhausted, through the apertures 111 and the connecting tube 131, into the aspirator. The bone chip is thereby removed from a human body in a bone surgery.

However, because the inner barrel 11 is installed entirely inside the suction handle 1, it is difficult for a medical person to remove the inner barrel 11 from the suction handle 1. Further, because the inner barrel 11 has an opening at its both ends, the bone chip stored therein is likely to slip out during the removal of the inner barrel 11. The medical person has to collect or dispose the bone chip immediately after removal of the inner barrel 11 rather than put the inner barrel aside and deal with the bone chip later. This collecting task is inconvenient for medical personal and further retards the proceeding of the bone surgery. In sum, the conventional suction set is unable to satisfy medical personals' demand.

### BRIEF SUMMARY OF THE INVENTION

The present invention provides a suction set structure for bone surgery which facilitates the removal and installation of the inner barrel of a suction set. The chip bone collected inside the inner barrel will not slip out during the removal of the inner barrel. The inner barrel is also capable of standing upright after removal.

The suction set provided by the present invention includes a suction handle, a suction tip, an inner barrel with a fixing mount which is installed inside the suction handle, and a rear cap. The suction tip connects to a front open end of the suction handle. The front open end of the suction handle connects to an open end of the inner barrel. The inner barrel has a plurality of apertures which permit blood and bone dust to pass through and enter into the connecting tube of the rear cap while the larger bone chip is collected inside the inner barrel. The fixing mount is secured to the rear of the inner barrel, adjacent to a close end of the inner barrel. The fixing mount includes a ring portion, a connecting portion, and a rib flange extending from the ring portion. The rib flange is installed between the rear open end of the suction handle and the rear cap. By utilizing the present invention a medical person is able to vertically detach the rear cap and the inner barrel from the suction handle. The bone chip collected inside the inner barrel will not slip out during the removal of the inner barrel. Further, the inner barrel is able to erect upright on a platform by the rib flange of the fixing mount.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a cross-sectional view of a conventional suction set for bone surgery.

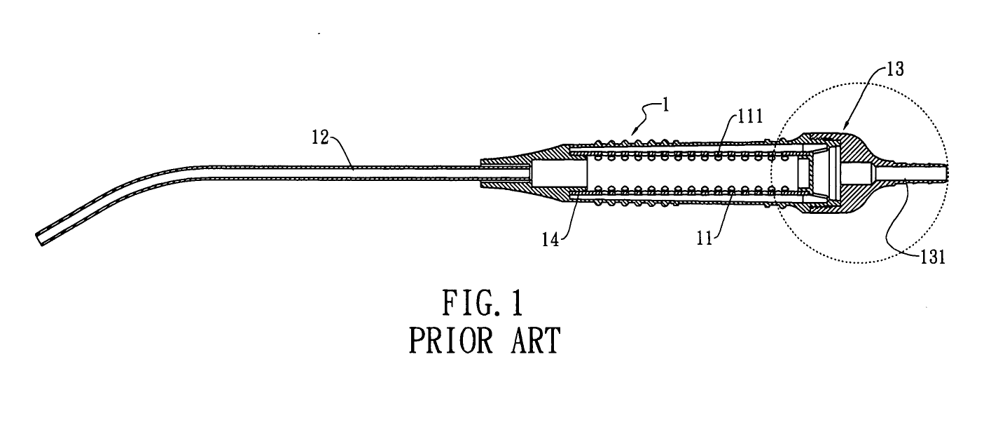

FIG. 2 is an enlarged partial cross-sectional view of a conventional suction set for bone surgery.

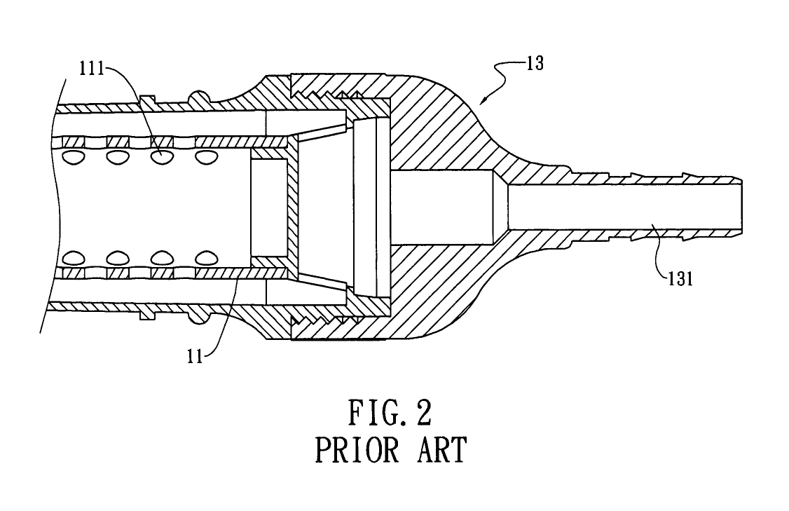

FIG. 3 is a perspective view of the present invention.

FIG. 4 is an exploded view of the present invention.

FIG. 5 is a perspective view of the present invention held by a medical person's right hand.

FIG. 6 is a cross-sectional view of the present invention illustrating the flow direction of the suction airflow generated by an aspirator.

FIG. 7 is an enlarged partial cross-sectional view of FIG. 6.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

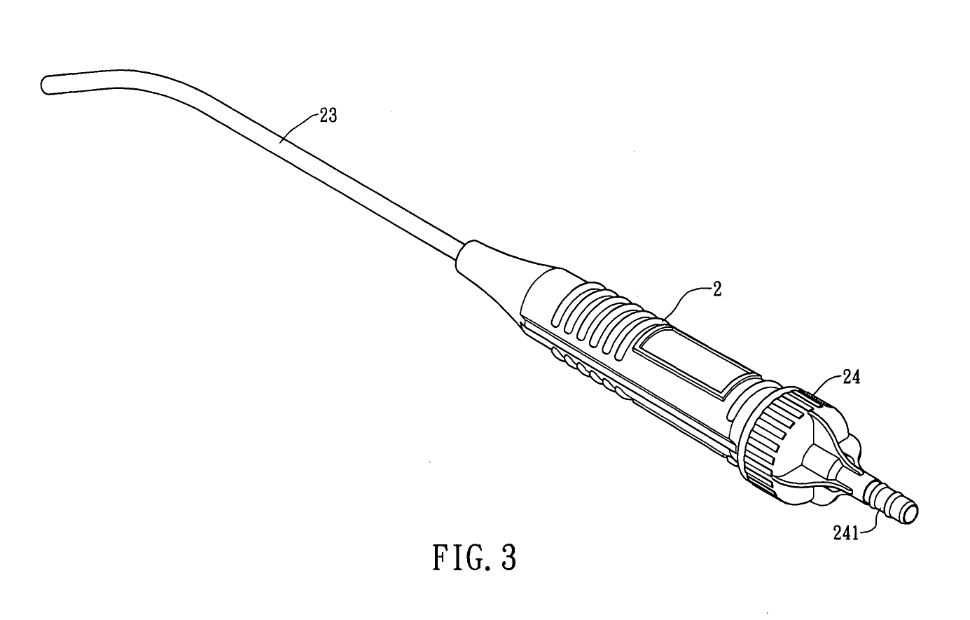

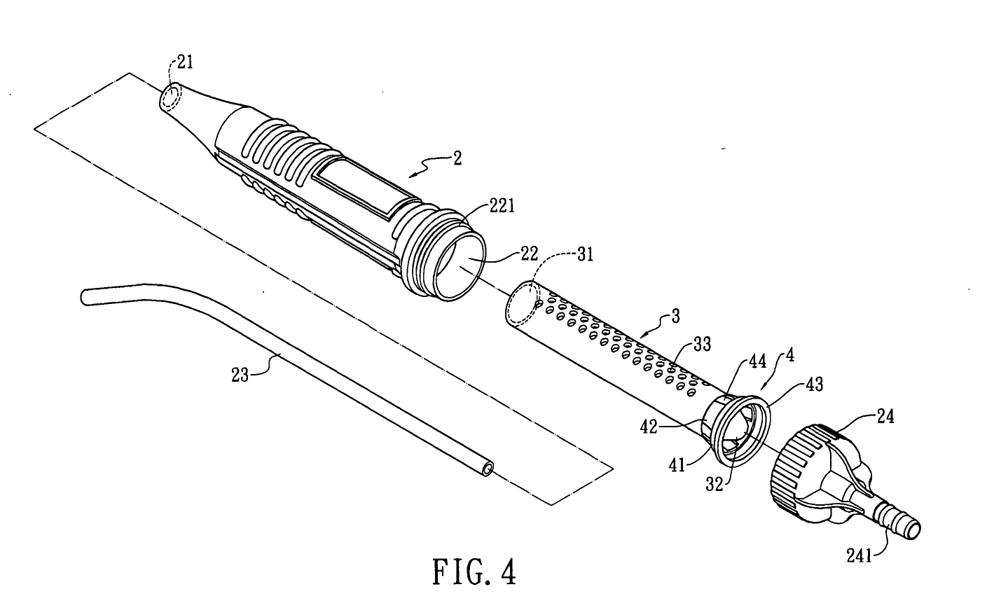

Referring to FIG. 3 and FIG. 4, a perspective view and an exploded view of the present invention are shown respectively. The suction set structure for bone surgery of the present invention includes a suction handle 2, a suction tip 23, an inner barrel 3 with a fixing mount 4, and a rear cap 24 with a connecting tube 241. The present invention facilitates the removal and the installation of the inner barrel 3 in the suction handle 2 of the suction set. The chip bone collected inside the inner barrel 3 will not slip out during the removal of the inner barrel 3. Further, the inner barrel 3 is capable of standing upright after removal.

The suction handle 2 has a front open end 21 and a rear open end 22 respectively formed at the front and the rear thereof. The front open end 21 connects to the suction tip 23. The rear open end 23 is capped with a rear cap 24 which has a connecting tube 241. The rear open end 23 has a conjunction portion 221 formed around the circumference thereof. Correspondingly, the rear cap 24 has an opposing conjunction portion 242 formed around its inner circumference. Further, an extending section 25, extending inwardly from the front open end 21, is formed inside the front portion of the suction handle 2.

The inner barrel 3, which is installed inside the suction handle 2, includes an open end 31, a close end 32 and a plurality of apertures 33. The open end 31 of the inner barrel is slipped onto the extending section 25 of the suction handle 2. The close end 32 of the inner barrel opposes to but not contacts with the connecting tube 242 of the rear cap 24. The close end 32 of the inner barrel 3 can be shaped into a half oval.

The fixing mount 4 is secured to the rear of the inner barrel 3, adjacent to the close end 32 of the inner barrel 3. The fixing mount 4 includes a ring portion 41, a connecting portion 42 which connects the ring portion 41 to the inner barrel 3, and a rib flange 43 extending from the ring portion 41. The rib flange 43 is installed between the rear open end 22 of the suction handle 2 and the rear cap 24. An opening 44 is formed between each connecting portions 42. Assembling the aforementioned components constitutes a whole new structure of a suction set for bone surgery.

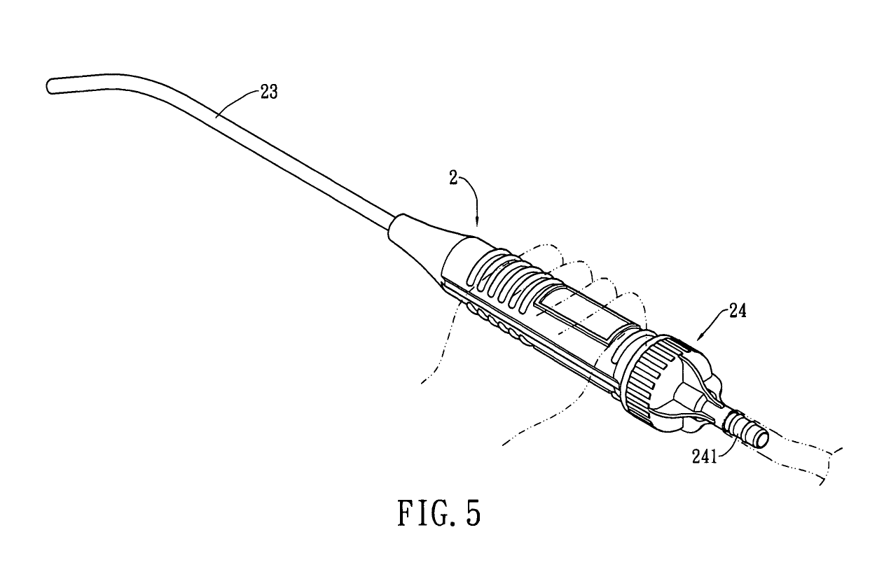

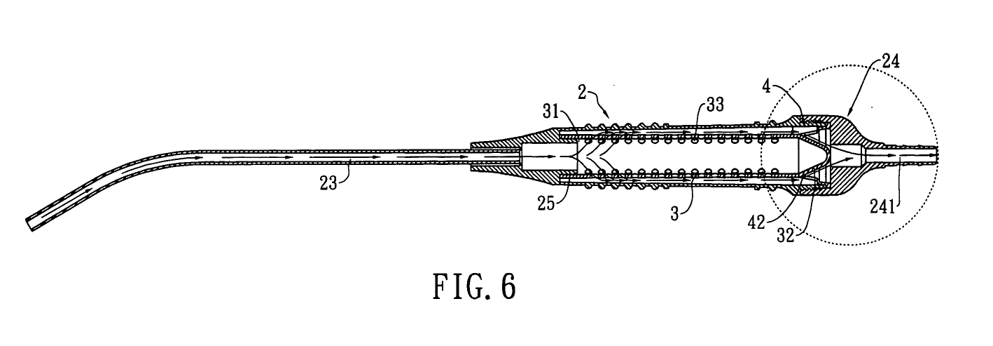

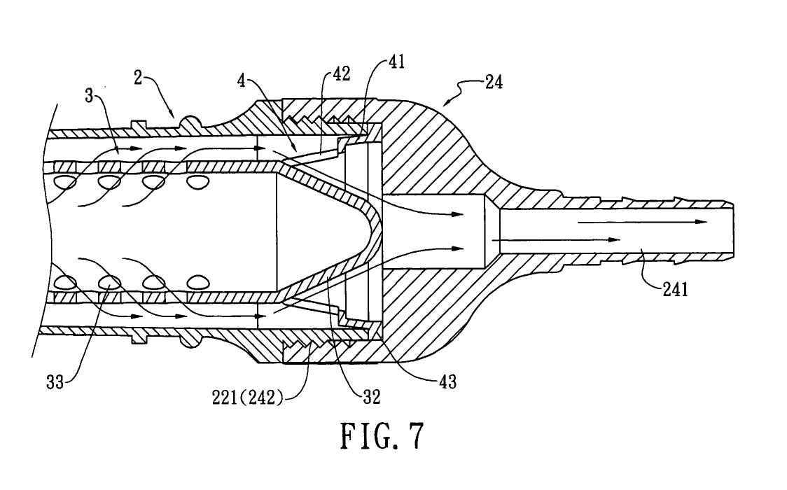

Referring to FIG. 5 through FIG. 7, the utilization of the present invention is illustrated. An aspirator, which is not shown in figures, connects to the connecting tube 241 of the rear cap 24. During the bone surgery, by utilizing the aspirator a medical doctor holds the suction handle 2 and uses the suction tip 23 to perform the suction task. The aspirator produces a suction airflow which first flows into the suction tip 23 and the inner barrel 3, then passes through the apertures 33, the openings 44, and the connecting tube 241, and finally arrived the aspirator.

During a bone chip suction procedure, blood and bone chips will be sucked by the suction tip 23 into the inner barrel 3. The blood and bone dust will be exhausted from the inner barrel 3 through the plurality of apertures 33 and further sucked through the opening 44 and the connecting tube 241 into the aspirator while the bone chips, which are larger than the bone dust, will be collected inside the inner barrel 3.

When the inner barrel 3 is filled with the bone chip, by utilizing the present invention a medical person is able to vertically detach the rear cap 24 and the inner barrel 3 from the suction handle 2. Because the fixing mount 4 of the inner barrel 3 is assembled with the rear cap 24, the inner barrel 3 will not have loose conditions during the detachment. Therefore, the bone chip will not slip out from the inner barrel 3. Further, after the inner barrel 3 is disconnected from the rear cap 24 the inner barrel 3 can be forwarded to another medical person, or erected on a platform by the rib flange 43 of the fixing mount 4. The removal of the inner barrel 3 of the present invention will not hinder the proceeding of the bone surgery.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. An inner barrel structure of a suction set for bone surgery, comprising:
a fixing mount;
a barrel body having a front open end and a rear close end received by and connected to the fixing mount; and
a plurality of apertures bored on the barrel body.

2. The inner barrel structure of a suction set for bone surgery of claim 1, wherein the fixing mount comprises a ring portion for standing and a connecting portion for connecting the barrel body.

3. The inner barrel structure of a suction set for bone surgery of claim 1, wherein the connecting portion provides at least an opening after receiving the barrel body.

4. A suction set structure for bone surgery, comprising:
a suction handle with an a front open end and a rear open end;
a suction tip assembled to the front open end of the suction handle;
a fixing mount;
an inner barrel with a plurality of apertures bored thereon, a front open end, and a rear close end received by and connected to the fixing mount, installed inside the suction handle; and
a rear cap for receiving the fixing mount and engaged to the rear open end of the suction handle.

5. The suction set structure for bone surgery of claim 4, wherein the rear open end of the suction handle has a conjunction portion formed around the circumference thereof while the rear cap has an opposing conjunction portion formed around the inner circumference thereof.

6. The suction set structure for bone surgery of claim 4, wherein the suction handle has a recess formed inside the front open end thereof for receiving the inner barrel from the front end thereof.

7. The suction set structure for bone surgery of claim 4, wherein the rear close end of the inner barrel is shaped into a half oval.

8. The suction set structure for bone surgery of claim 4, wherein the fixing mount comprises a ring portion for standing and a connecting portion for receiving the inner barrel.

9. The suction set structure for bone surgery of claim 8, wherein the connecting portion provides at least an opening after receiving the barrel body.

10. The suction set structure for bone surgery of claim 8, wherein the fixing mount further comprise a rib flange extending from the ring portion, and the rib flange is located between the rear open end of the suction handle and the rear cap so that the fixing mount is securely received in the rear cap by the suction handle.
